(19) United States
(12) Patent Application Publication
(10) Pub. No.: US 2007/0252024 A1
(43) Pub. Date: Nov. 1, 2007

(54) Reciprocating blade and circumferentially driven blade food preparation device

(76) Inventor: James R. Barraclough, Lanchashire (GB)

Correspondence Address: STEVEN A. GARNER, ESQ.;CONAIR CORPORATION, ONE CUMMINGS POINT ROAD, STAMFORD, CT, 06902, US

(21) Appl. No.: 11/714,961

(22) Filed: Mar. 7, 2007

Related U.S. Application Data
(60) Provisional application No. 60/779,859, filed on Mar. 7, 2006.

(51) Int. Cl. A47J 44/00

(52) U.S. Cl. 241/92

(57) ABSTRACT

A food processing appliance for multiple purposes having one or more driven blades. A motorized, electrically powered reciprocating blade food preparation appliance that performs similar tasks as a mandoline slicer and, optionally, has a rotational blade that is mounted and driven in a novel manner to conserve space and make efficient use of a motor.

### CROSS-REFERENCE TO RELATED APPLICATIONS

This application claims priority to U.S. Provisional Patent Application Ser. No. 60/779,859 filed on Mar. 7, 2006, incorporated herein by reference in its entirety.

### TECHNICAL FIELD

The present invention relates to food processing appliances and, more particularly, to food processing appliances for multiple purposes having one or more driven blades.

### BACKGROUND OF THE INVENTION

Known food processor appliances typically have a single rotating motor driven shaft to which a round blade disc is mounted, having various features for different types of food cutting operations. Such devices are limited to rotational motion cutting and feeding through a chute mounted above the blade. Center-mounted drive shafts in such devices are required to have high torque and rotational rate outputs to achieve desired cutting.

Another type of known device is referred to as a “mandoline” slicer and is a stationary plate having blades and perforations, similar to a cheese grater, and food is manually reciprocated across the blades. No power-driven mandoline slicers are known to exist.

### OBJECTS OF THE INVENTION

It is an object of the present invention to provide a motorized, electrically powered reciprocating blade food preparation appliance that performs similar tasks as a mandoline slicer and, optionally, has a rotational blade that is mounted and driven in a novel manner to conserve space and make efficient use of a motor.

These objects, as well as others, are achieved by the present invention.

### BRIEF SUMMARY OF THE INVENTION

The present invention achieves the above-mentioned objects by utilizing a motor-driven reciprocating blade for cutting food products in one instance, and a circumferentially-driven rotating disc blade for cutting food products in another instance.

### BRIEF DESCRIPTION OF THE DRAWINGS

FIG. 1 is a schematic, orthogonal view of an appliance according to the present invention.

FIG. 2A-2H are, respectively, bottom orthogonal, top orthogonal, first side, second side, front end, rear end, top, and bottom schematic views of a component of the present invention. is a schematic, orthogonal view of individual components of the present invention.

FIG. 3 is a schematic, orthogonal view of individual components of the present invention.

FIG. 4 is a schematic, orthogonal view of individual components of the present invention.

FIG. 5 is a schematic, orthogonal view of individual components of the present invention.

### DESCRIPTION OF THE PREFERRED EMBODIMENTS

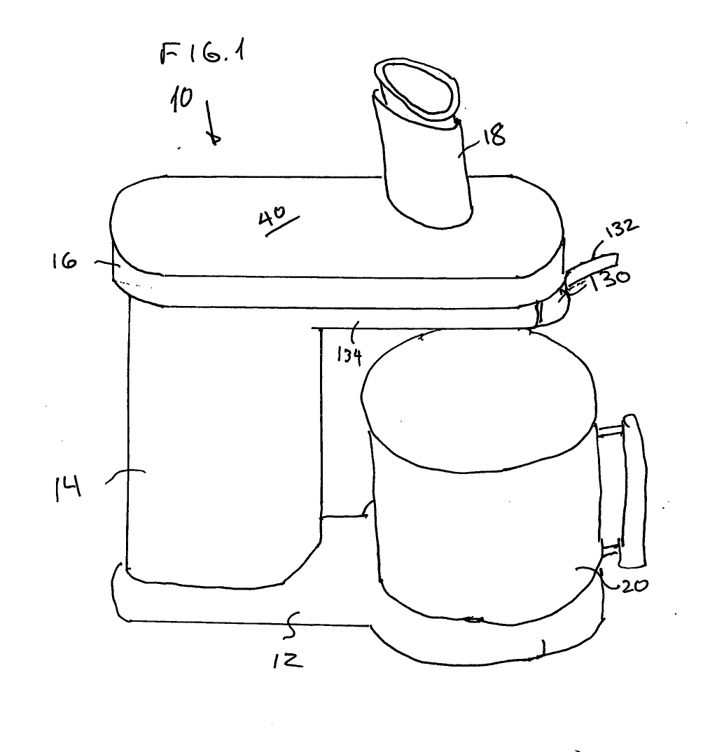

An appliance 10 according to a first embodiment of the present invention is illustrated schematically in FIG. 1. It comprises a base 12, a vertical section 14 housing a conventional electric motor (not shown) therein, an upper section 16, a feed chute 18, and a bowl 20 removably mounted to the base 12.

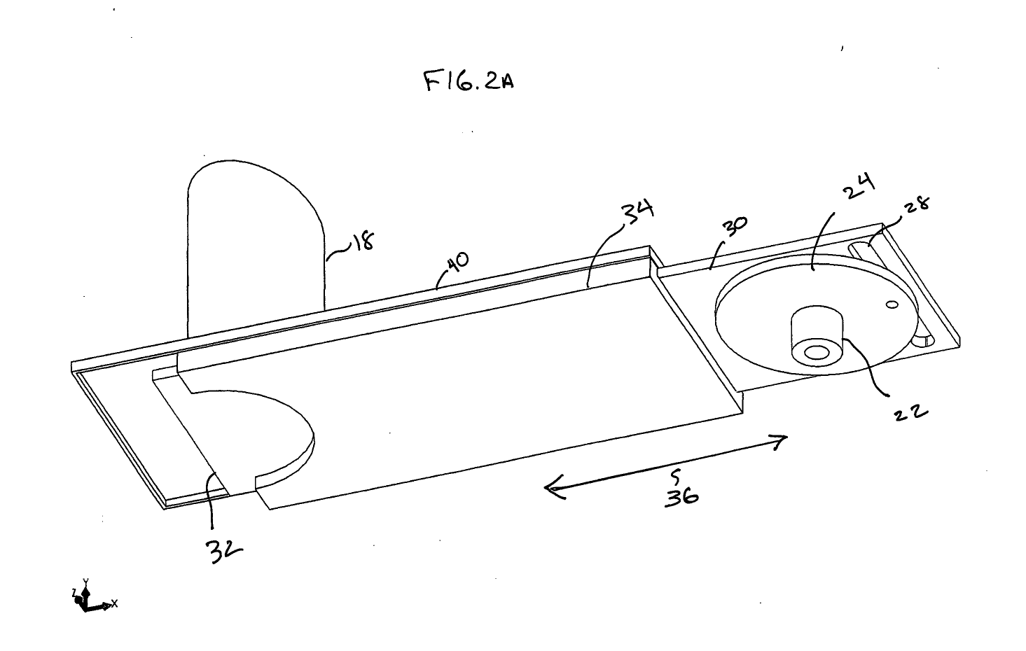

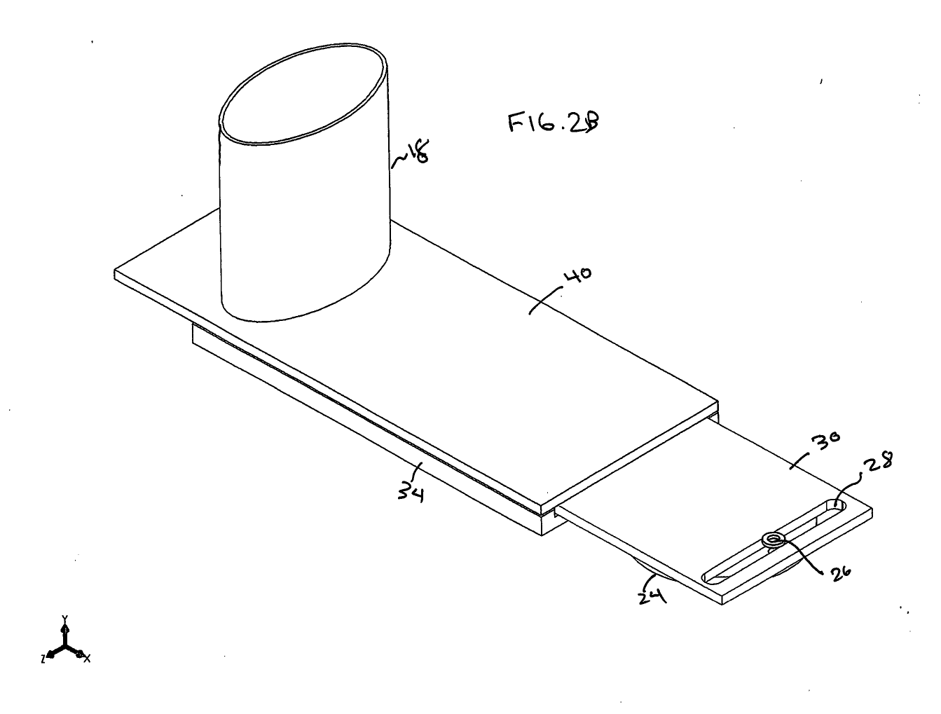

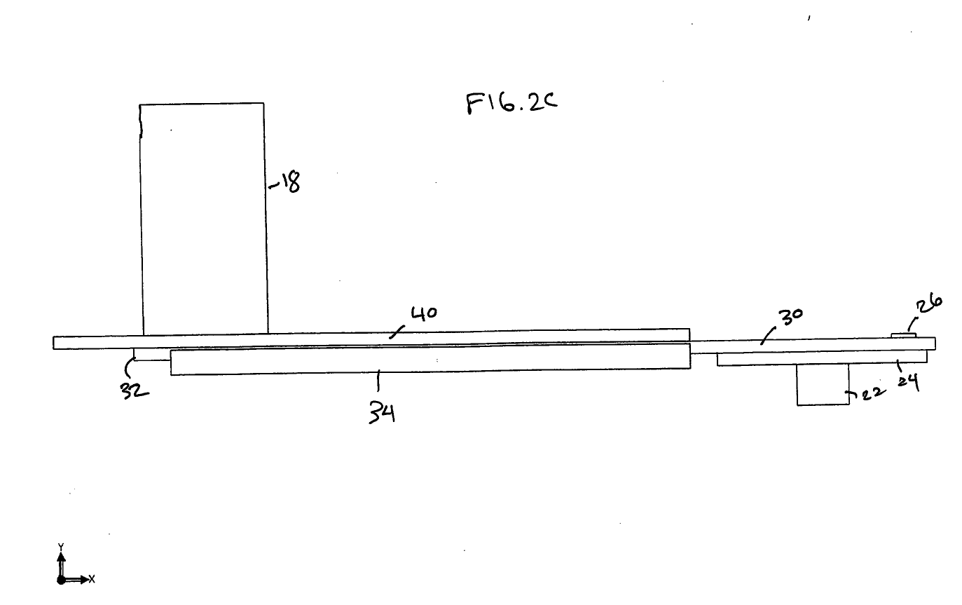

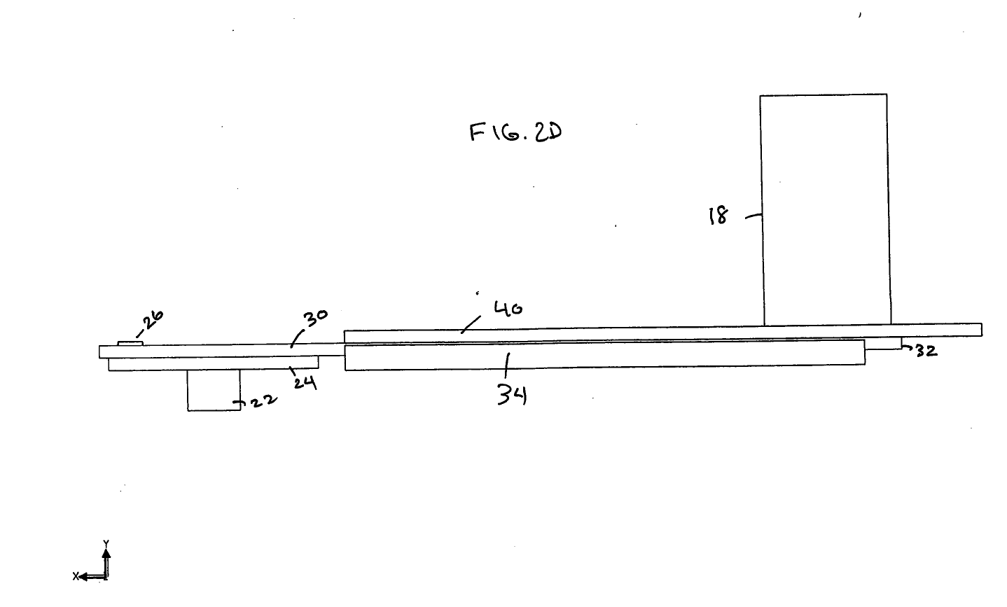

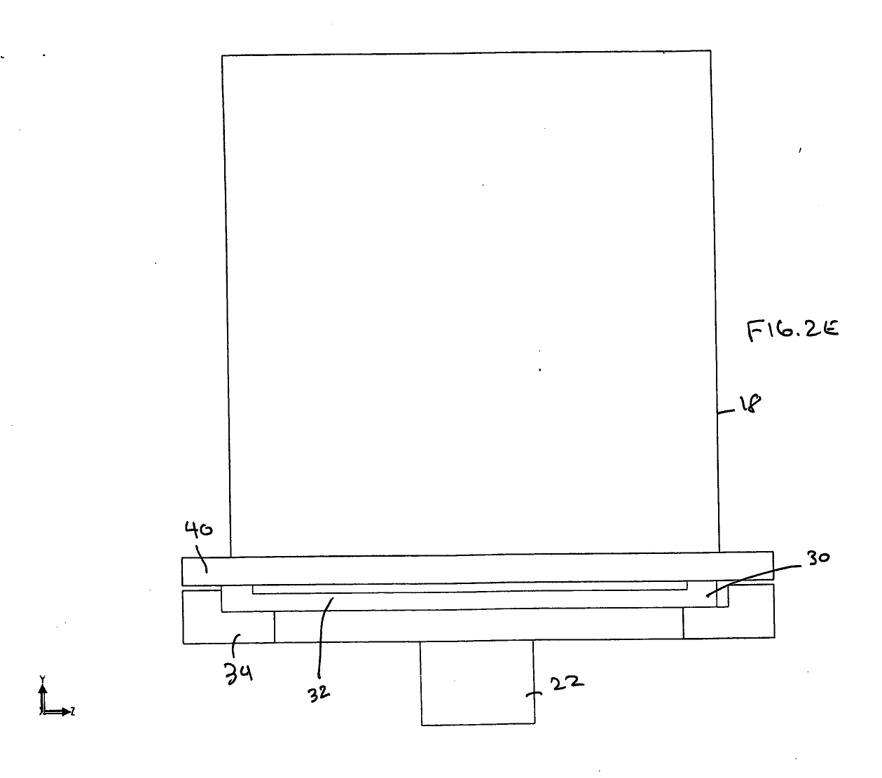

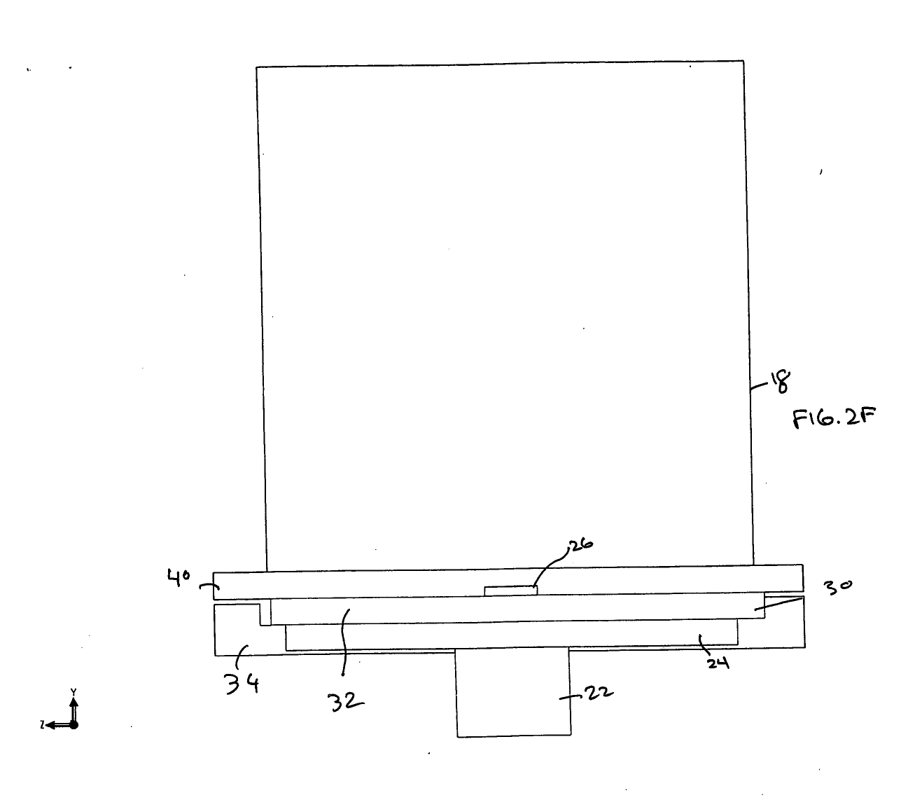

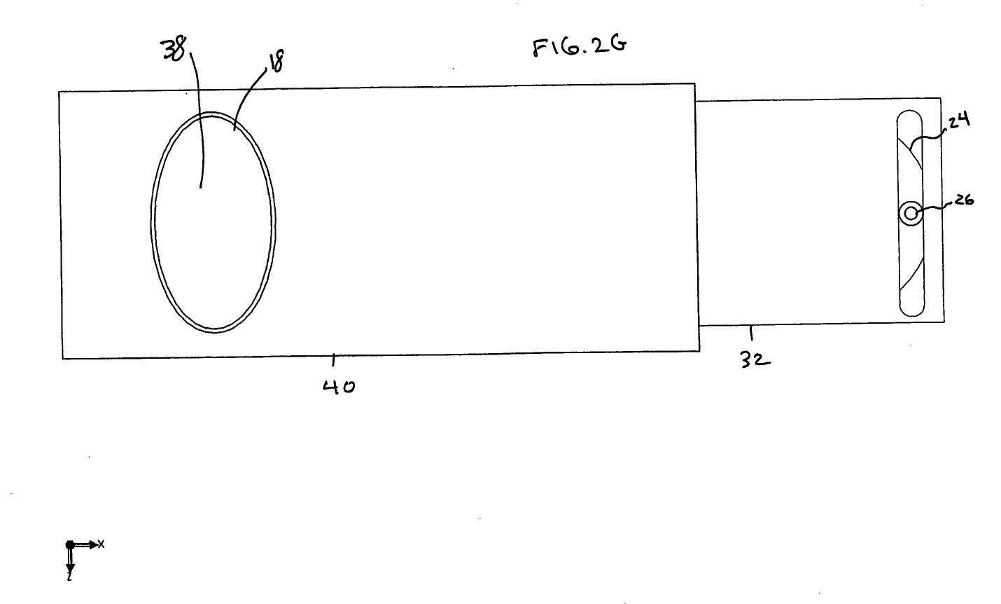

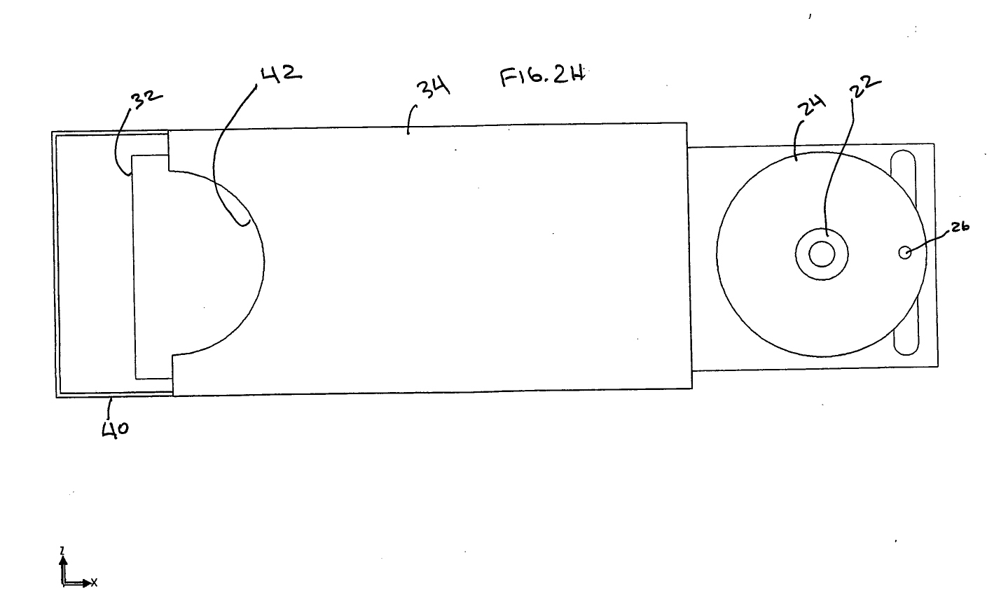

FIGS. 2A-2H illustrate, schematically, the internal components housed in the upper section 16 that comprise a reciprocating, motor driven blade assembly. A driven shaft 22 attached to a driven disc 24 causes a drive pin 26 to rotate about the shaft 22, as the shaft 22 is connected to a rotatable output (not shown) of a conventional electric motor (not shown). The drive pin 26 is received in a drive slot 28 of a blade plate 30. The blade plate 30 has a leading edge 32 that can be sharpened to function as a cutting blade or it can have a blade plate (not shown) attached to it. A receiving sleeve 34 receives the blade plate 30 for reciprocating motion therein. When the electric motor is driven and causes the drive shaft 22 and disc 24 to rotate, the pin 26 travels in a′ rotational path about the shaft 22. Because the pin 26 is constrained in the slot 28, it is moves the blade plate 30 reciprocally within the receiving sleeve 34 in the directions indicated by the arrow 36 in FIG. 2A. This causes the leading, blade edge 32 to cut food product placed in its path.

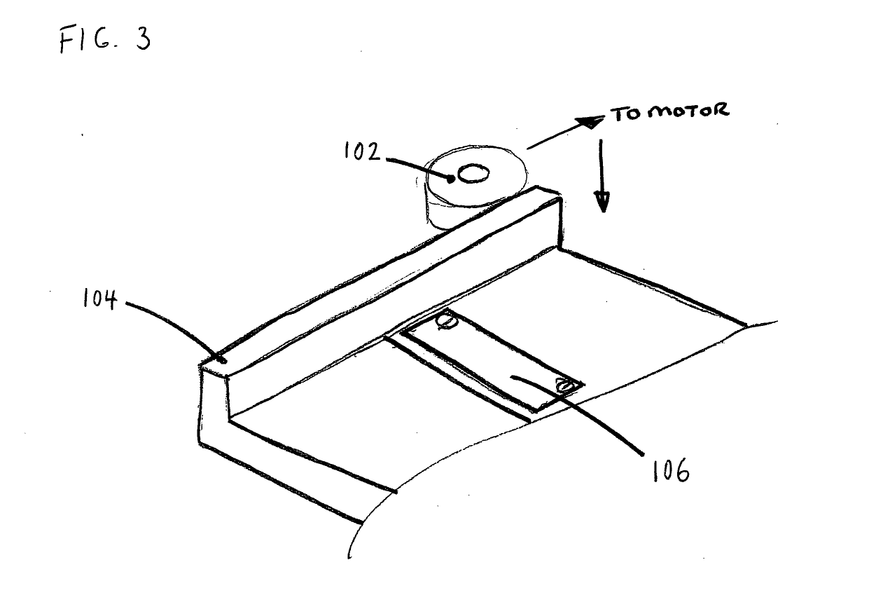

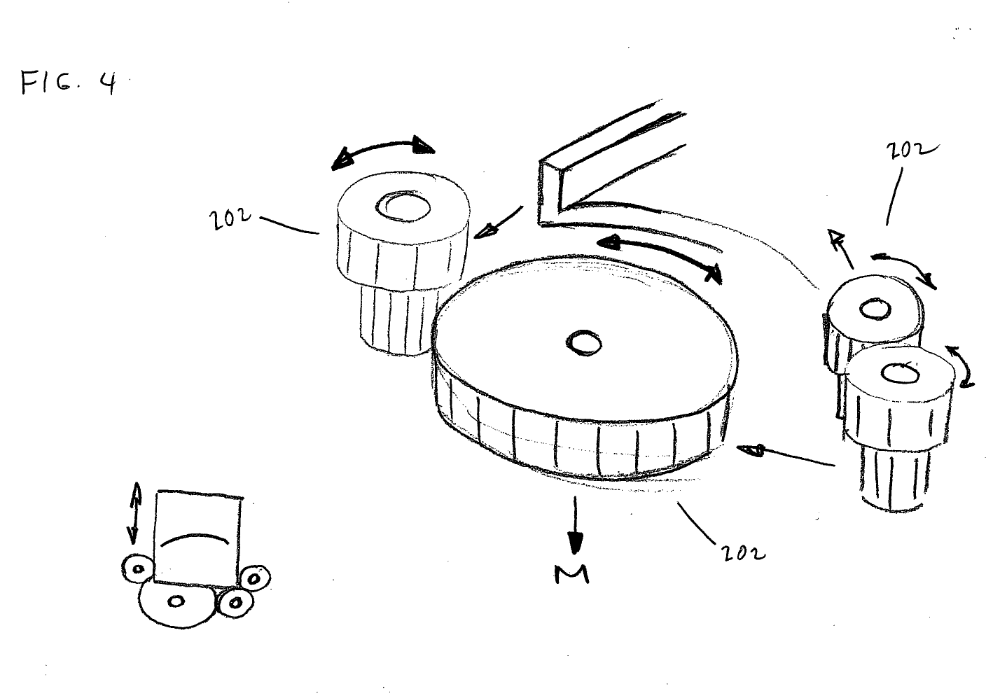

FIG. 3 shows another embodiment of the present invention, whereby a rack and pinion assembly can be used to drive a mandolin-chopping blade in a back and forth motion. This assembly preferably includes a motor (not shown), at least 4 drive gears 102 depending on the desired gear ratio and the sliding blade. The motor causes the gear 102 to rotate, thereby driving the rack 104 and, therefore, the cutting surface 106, in a back and forth motion. A similar approach, as shown in FIG. 4, would be to have multiple gears 202 being driven by the motor to operate the rack and pinion for added support and/or guidance, etc.

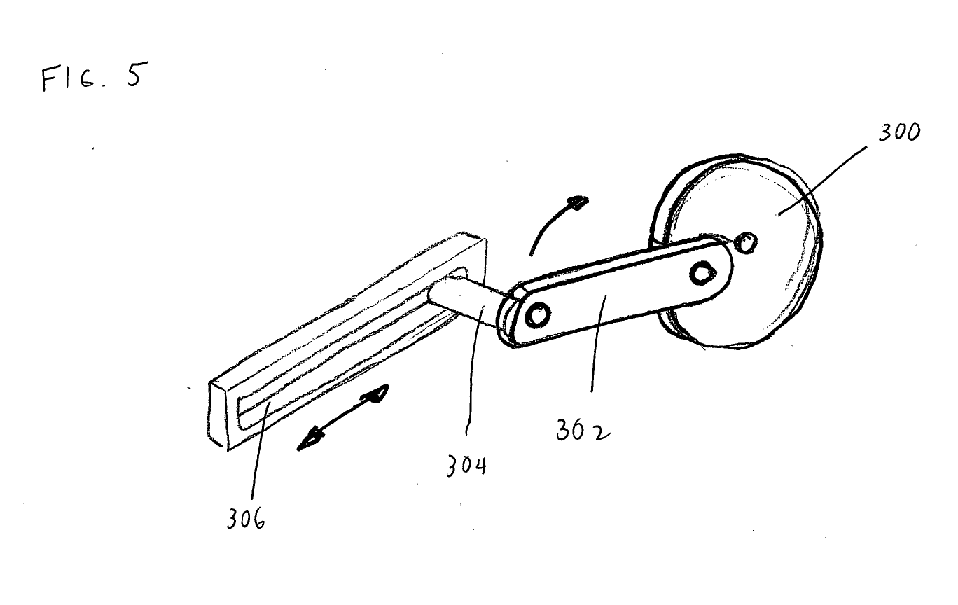

FIG. 5 shows another alternate embodiment, whereby an arm and cam arrangement, similar to a locomotive, is used to drive the mandolin-chopping blade. As the cam gear 300 rotates it causes the cam lever 302 to push the cam pin 304 back and forth in the cam slot 306, which causes the blade to move in a back and forth motion.

While the preferred embodiments of the present invention have been herein described, various modifications may be made without departing from the scope of the present invention.

What is claimed is:

1) A food appliance comprising
a base;
a housing;
an electric motor mounted in said housing;
a drive output connected to said motor;
a first blade adapted for reciprocating motion within said housing;
a first drive assembly driven by said drive output for imparting reciprocating motion to said first blade, wherein said first drive assembly comprises a rotatable cam gear coupled to a driven linkage arm which has a pin attached thereto, whereby said pin rides in a slot when said gear rotates to impart reciprocating motion to said pin and to said first blade; and
a food product feed assembly for feeding food product to said blade while it is reciprocating causing said food product to be cut.

2) An appliance according to claim 1, further comprising
a second blade adapted for rotational motion; and
a second drive assembly driven by said drive output for imparting rotational motion to said second blade in order to cut said food product.

3) An appliance according to claim 2, further comprising
a gear surface attached to an outer circumferential surface of said second blade;
at least one driven gear driven by said drive output and engaging said gear surface in order to impart rotational motion to said second blade.

4) An appliance according to claim 1, further comprising
a third blade adapted for rotational motion; and
a third drive assembly driven by said drive output for imparting rotational motion to said third blade in order to cut food product, wherein said third blade is mounted to said base.

5) An appliance according to claim 4, further comprising
a bowl having an opening in its bottom surface adapted to receive a portion of said third drive assembly therethrough when said bowl is positioned on said base and when said third blade is operatively connected to said third drive assembly.
